(19) United States
(12) Patent Application Publication
(10) Pub. No.: US 2021/0024802 A1
(43) Pub. Date: Jan. 28, 2021

(54) METHOD OF PRODUCING SERIES OF PHASE-CHANGE WAX PRODUCTS

(71) Applicant: Inner Mongolia Yitai Coal-based New Materials Research Institute Co., Ltd, Erdos (CN)

(72) Inventors: Juncheng LI, Erdos (CN); Heng MIAO, Erdos (CN); Zhen QIAN, Erdos (CN); Huiyue ZHENG, Erdos (CN); Guoqing MA, Erdos (CN); Yan ZHOU, Erdos (CN); Qinge JIAN, Erdos (CN); Lianglan GUO, Erdos (CN)

(21) Appl. No.: 17/042,790

(22) PCT Filed: Jun. 10, 2019
(86) PCT No.: PCT/CN2019/090561

§ 371 Date: Sep. 28, 2020

(30) Foreign Application Priority Data
Jun. 22, 2018 (CN) 201810659572.9

(51) Int. Cl. C09K 5/06; C10G 73/44; C10G 73/42; C10G 73/40

(52) U.S. Cl. CPC C09K 5/063; C10G 73/44; C10G 2300/304; C10G 73/40; C10G 2300/1022; C10G 73/42

(57) ABSTRACT

Disclosed is a method for producing series of phase change wax products, comprising: refining a Fischer-Tropsch synthesis wax raw material via a hydrogenation reaction to obtain a refined Fischer-Tropsch wax; and subjecting the refined Fischer-Tropsch wax to reduced pressure distillation to separate continuous fractions with a distillation range of 5° C.-30° C. by continuously increasing the operation temperature so as to obtain series of phase change wax products, wherein the pressure for the reduced pressure distillation is 0-1000 pa, the operation temperature at the top of the column is 120° C.-260° C., and the phase change enthalpy value of the series of phase change wax products is ≥170 J/g. According to the method, phase change wax products of various grades with melting points from 5° C. to 80° C. can be separated and produced from the refined Fischer-Tropsch wax. The products have concentrated carbon numbers and relatively high enthalpy values. The process products have relatively high flexibility, can be customized on demand, and have low production cost, and the industrial production of the products can be realized.

### TECHNICAL FIELD

The present invention belongs to the technical field of chemical engineering, and specifically relates to a method of producing series of phase-change wax products.

### BACKGROUND

Phase-change energy storage materials utilize the phase change process of the materials to absorb heat (cold) from the environment or release heat (cold) to the environment, so as to achieve the purpose of storing or releasing energy, and regulating the mismatch of demand and supply of energy. The phase-change energy storage wax is one of phase-change energy storage materials, which can effectively avoid the supercooling phenomenon and the phase separation phenomenon of the inorganic phase-change materials, and overcome defects such as the inorganic phase-change materials cannot be used repeatedly. Generally, a phase-change material is required to have a proper phase-change temperature and a large latent heat of phase change. According to the temperature range of energy storage, the phase-change energy storage wax can be divided into high-temperature, medium-temperature, low-temperature types and the like. The low- and medium-temperature phase-change wax can be widely used in civil fields including energy conservation of buildings, agriculture facility, daily necessities (such as temperature-adjusting textile fabrics, heat-proof shells of electric appliance and the like) and the pharmaceutical industry. The high-temperature phase-change wax is mainly used in the fields of solar energy utilization, hot water systems, electronic elements, automatic control and the like.

The Fischer-Tropsch synthetic wax, as a methylene polymer, is a mixture of alkanes obtained by catalytic polymerization of synthetic gas at medium temperature and medium pressure. The composition of Fischer-Tropsch synthetic wax is relatively simple, wherein the content of straight-chain normal-alkanes is more than 90%, and the rest are substantially branched alkanes. Straight-chain normal-alkanes substantially do not contain cyclic hydrocarbons or aromatic hydrocarbons. Compared to isomeric-alkanes and cycloalkanes, the phase-change latent heat of normal-alkanes is greater, and the Fischer-Tropsch wax is chemically stable, non-corrosive and does not pollute the environment, which is exactly the biggest advantage of Fischer-Tropsch wax for using to produce the phase-change wax. However, the Fischer-Tropsch wax has a wider range of carbon number distribution, and has a lower phase-change latent heat when directly used as a phase-change wax material, and a wider phase-change range. Meanwhile, the small amount of isomeric-alkanes contained therein also affects the improvement of the phase-change latent heat.

The refined Fischer-Tropsch wax has a wide range of carbon number distribution, with a maximum carbon number of more than 100. A low-, medium- and high-temperature series of phase-change wax products can be produced by precision fractionation. In one technical solution of prior art, the following steps are performed: a coal-based Fischer-Tropsch synthetic wax is used as a raw material, a fraction of low-temperature phase-change wax product is obtained by molecular short-path distillation, and a stable phase-change wax product is obtained by adding NNO. The separation accuracy of molecular short-path distillation is lower than that of rectification device, which shows that the product has a wider carbon number distribution and a lower enthalpy value, and that the phase-change enthalpy values of the phase-change wax at the temperature of more than 40° C. are not higher than 160 J/g; and the separated fraction can form a stable product by adding NNO.

In another technical solution, diesel fuel fraction wax is used as a raw material, and 20#, 25#, 30# and 35# low-melting-point phase-change wax products are produced through the process of solvent dewaxing and precision cutting of real-boiling-point, wherein the phase-change enthalpy is more than 120 J/g. When the low-temperature phase-change wax is produced by using petroleum wax as a raw material, the raw material needs to be subjected to solvent dewaxing to increase the content of normal-hydrocarbon in the raw material, so as not to affect the increase of enthalpy value of a product. The product has a lower phase-change enthalpy value and is limited by the structure of the raw material. So there are fewer types of phase-change wax products.

### SUMMARY OF THE INVENTION

To address the defects of the above technologies, by utilizing the advantages of the unique structure of Fischer-Tropsch synthetic wax, and further reducing the content of isomeric-hydrocarbon, thereby increasing the content of normal-hydrocarbon by more than 95%, and then designing a reduced pressure rectification device and controlling the operating conditions of the device, series of phase-change wax fractions with a narrow distribution of carbon number and a high enthalpy value are separated in the present invention. The product fractions are continuous, and series of phase-change waxes with a melting point of 5-80° C. could be obtained.

In order to achieve the purpose, the following technical solutions are used in the present invention:
a method of producing series of phase-change wax products, comprising:
refining a Fischer-Tropsch synthetic wax raw material via hydrogenation reaction to obtain a refined Fischer-Tropsch wax;
subjecting the refined Fischer-Tropsch wax to reduced pressure distillation, separating continuous fraction with the distillation range of 5-30° C. by continuously increasing the operation temperature, to obtain series of phase-change wax products, wherein the pressure of the reduced pressure distillation is 0-1000 pa, the operation temperature at the top of the column is 120-260° C., and the phase-change enthalpy value of the series of phase-change wax products is ≥170 J/g.

Preferably, the operation temperature of the hydrogenation reaction is 240-340° C., and the operation pressure is 3-8 MPa.

Preferably, the freezing point of the refined Fischer-Tropsch wax is 40-90° C.

Preferably, the method further comprises, before the reduced pressure distillation, reducing the content of isomeric-hydrocarbon in the refined Fischer-Tropsch wax to increase the content of normal-alkane in the raw material to 95% or more.

Preferably, the method of reducing the content of the isohydrocarbon in the refined Fischer-Tropsch wax is selected from sweating or solvent deoiling, preferably dilution with butanone and crystallization in steps.

Preferably, the reduced pressure distillation comprises: under the conditions of a pressure of 1000 Pa and an operation temperature of 140-150° C. at the top of the column, the fraction at the temperature of 280-300° C. is separated, with a melting point of 15±2.5° C. and a phase-change enthalpy value of ≥170 J/g; under the condition of an operation temperature of 150-160° C. at the top of the column, the fraction at the temperature of 300-315° C. is separated, with a melting point of 20±2.5° C. and a phase-change enthalpy value of ≥170 J/g; under the condition of an operation temperature of 160-170° Cat the top of the column, the fraction at the temperature of 315-330° C. is separated, with a melting point of 25±2.5° C. and a phase-change enthalpy value of ≥170 J/g; series of phase-change wax products having a melting point of 60° C. can be separated by continuously increasing the operation temperature.

Preferably, the reduced pressure distillation comprises: under the conditions of a pressure of 10 Pa and an operation temperature of 115-130° C. at the top of the column, the fraction at the temperature of 350-375° C. is separated, with a melting point of 35±2.5° C. and a phase-change enthalpy value of ≥180 J/g; under the condition of an operation temperature of 130-145° C. at the top of the column, the fraction at the temperature of 375-400° C. is separated, with a melting point of 45±2.5° C. and a phase-change enthalpy value of ≥190 J/g; under the condition of an operation temperature of 145-160° Cat the top of the column, the fraction at the temperature of 400-425° C. is separated, with a melting point of 50±2.5° C. and a phase-change enthalpy value of ≥190 J/g; series of phase-change wax products having a melting point up to 60° C. can be separated by continuously increasing the operation temperature.

Preferably, the carbon number of each phase-change wax product is 3-5.

Preferably, the phase-change temperature of the series of phase-change wax products is 5-80° C.

The technical solution of the present invention has the following beneficial effects in view of the prior art:

1. The Fischer-Tropsch wax is selected as a raw material. The composition of Fischer-Tropsch wax is simple, wherein the content of straight-chain normal-alkanes is more than 90%, and the rest are substantially branched alkanes, and it substantially does not contain cyclic hydrocarbons or aromatic hydrocarbons. Compared with isomeric-alkanes and cycloalkanes, the phase-change latent heat of the normal-alkanes is greater, and the refined Fischer-Tropsch wax is chemically stable, non-corrosive and does not pollute the environment. Therefore, the Fischer-Tropsch wax is an ideal raw material for producing the phase-change wax.

2. Compared with the separation of refined Fischer-Tropsch wax by molecular distillation (short path distillation), the invention has the following advantages: according to the properties (melting point of 5-80° C.) of the product of interest, the separated components are lighter, and the reduced pressure degree and the temperature are not required to be very high; less cracking of material occurs, so a wiped film evaporator which is expensive and difficult to operate is not required to be used. Instead, a reduced pressure rectification device can be used to accurately separate narrow-range components, reducing the difficulty of operation and the cost of hardware. At the same time, the method has high accuracy for product separation. Through the design of the rectification column and the control of operating conditions, continuous separation of fractions with a distillation range of 5-30° C. can be achieved, and finally phase-change wax products of various grades with melting points of 5-80° C. can be separated from the refined Fischer-Tropsch wax. The products have narrow carbon number range and relatively high enthalpy values (more than 170 kJ/kg).

3. The products of the process have the advantages of high flexibility, can be customized on demand, have low production cost. The industrial production of the products can be realized.

### SPECIFIC MODE FOR CARRYING OUT THE INVENTION

In order to make the purposes, technical solutions and advantages of the present invention more apparent, the present invention is further described in detail with reference to specific Examples.

In the present invention, Fischer-Tropsch synthetic wax is selected as a raw material for preparing series of phase-change wax products, and a method for preparing a phase-change wax with a simple process is provided, including the following steps: firstly, the Fischer-Tropsch synthetic wax is refined by hydrogenation reaction, to effectively remove substances such as olefins, oxygen-containing compounds and the like which may influence the product quality. The refined Fischer-Tropsch wax is treated by solvent removal of isomeric-hydrocarbon to make the content of normal-alkane to be 95% or more; Through separation by reduced pressure distillation and controlling the distillation range of the separated fraction within 5-30° C., series of phase-change wax products with high-quality can be separated, wherein the content of normal-hydrocarbon is 95% or more and the carbon number is mainly 3-5 carbons. This method has the following advantages: realizing customized production on demand, realizing the full utilization of raw materials, reducing waste, reducing costs and effectively improving economic benefit.

In one embodiment, a low-temperature Fischer-Tropsch synthetic wax is used as a raw material, and a refined Fischer-Tropsch wax is obtained by hydrogenation reaction. The operation temperature of the hydrogenation reaction is 240-340° C., and the operation pressure is 3-8 Mpa. The purpose of refinement by hydrogenation reaction is to saturate a small amount of olefins in the Fischer-Tropsch synthetic wax, reduce a small amount of oxygen-containing organic compounds in the Fischer-Tropsch synthetic wax and break the chains of a small amount of polycyclic hydrocarbons in the Fischer-Tropsch synthetic wax.

If these substances are not removed, on the one hand, they will affect the color of the products separated from Fischer-Tropsch wax, and on the other hand, it is easy to generate coking and carbon deposition in the subsequent processing, thereby influencing the quality and normal production of the products. The isomeric-hydrocarbon can be further removed from the refined Fischer-Tropsch wax by sweating, solvent deoiling and other means of removing isomeric hydrocarbons.

In one embodiment, a butanone solvent is used as a single solvent to dilute the oil-containing Fischer-Tropsch wax, and after a pre-dilution, first dilution, second dilution and third dilution and crystallization by cooling, a solvent-containing crystallization liquid is obtained. The crystallization liquid is filtered by a filter to obtain deoiled cerate, and the deoiled cerate is evaporated to recover the solvent to obtain the product of wax. When the dilution is carried out for many times, excessive consumption of cooling calories in single cooling can be avoided, and the energy consumption for cooling is saved. The normal-alkane content of the deoiled refined Fischer-Tropsch wax is increased to more than 95% (the step is determined by the normal-hydrocarbon content in the raw material, and if the normal-hydrocarbon content in the raw material reaches more than 95%, this step can be omitted).

The refined Fischer-Tropsch wax is separated in a packed rectification column with a reaction pressure of 0-1000 Pa and a temperature at the top of the column of 120-260° C. Continuous fractions with a distillation range of 5-30° C. can be separated and divided into phase-change wax products of various grades according to the melting point of each fraction. The invention can obtain series of phase change wax products with stable phase change temperature at 5-80° C.

### Example 1

A low-temperature Fischer-Tropsch synthetic wax is used as a raw material and refined by hydrogenation reaction to obtain a refined Fischer-Tropsch wax, wherein the freezing point is 45° C., the initial boiling point is 286° C., and the normal-alkane content in the raw material wax is 95.3%.

The refined Fischer-Tropsch wax is subject to the following steps: under a pressure of 1000 Pa and an operation temperature of 140-150° C. at the top of the column, a fraction at the temperature of 280-300° C. is separated, with a melting point of 15±2.5° C. and a phase-change enthalpy value of ≥170 J/g; continuously increasing the operation temperature of the rectifying column, under the condition of an operation temperature of 150-160° C. at the top of the column, a fraction at the temperature of 300-315° C. was separated, with a melting point of 20±2.5° C. and a phase-change enthalpy value of ≥170 J/g; continuously increasing the operation temperature of the rectifying column, under the condition of an operation temperature of 160-170° C. at the top of the column, a fraction at the temperature of 315-330° C. was separated, with a melting point of 25±2.5° C. and a phase-change enthalpy value of ≥170 J/g; with the continuous increase of the operation temperature of the rectifying column, phase-change wax fractions of various grades with distillation range of 10° C. and melting point of 15-55° C. can be separated according to requirements and can be directly used as a phase-change wax product.

### Example 2

A Fischer-Tropsch synthetic wax is used as a raw material and refined by hydrogenation reaction to obtain a refined Fischer-Tropsch wax, wherein the freezing point is 85° C., the normal-alkane content is 92.1%, and the normal-alkane content reaches 98.3% after dilution with butanone and deoiling by crystallization in steps.

The refined Fischer-Tropsch wax is subject to the following steps: under a pressure of 10 Pa and an operation temperature of 115-130° C. at the top of the column, a fraction at the temperature of 350-375° C. is separated, with a melting point of 35±2.5° C. and a phase-change enthalpy value of ≥180 J/g; continuously increasing the operation temperature of the rectifying column, under the condition of an operation temperature of 130-145° C. at the top of the column, a fraction at the temperature of 375-400° C. was separated, with a melting point of 45±2.5° C. and a phase-change enthalpy value of ≥190 J/g; continuously increasing the operation temperature of the rectifying column, under the condition of an operation temperature of 145-160° C. at the top of the column, a fraction at the temperature of 400-425° C. was separated, with a melting point of 50±2.5° C. and a phase-change enthalpy value of ≥190 J/g; with the continuous increase of the operation temperature of the rectifying column, phase-change wax fractions of various grades with distillation range of 20° C. and melting point of 25-80° C. can be separated according to requirements and can be directly used as a phase-change wax product.

The specific Examples described above further describe the purpose, technical solutions and beneficial effects of the present invention in detail. It should be understood that the above are only specific examples of the present invention and are not intended to limit the present invention, any modifications, equivalent replacements, improvements and the like sithin the spirit and principle of the present invention should be included in the scope of the present invention.

1. A method of producing series of phase-change wax products, characterized in that it comprises:
refining a Fischer-Tropsch synthesis wax raw material via a hydrogenation reaction to obtain a refined Fischer-Tropsch wax;
subjecting the refined Fischer-Tropsch wax to reduced pressure distillation, separating continuous fractions with a distillation range of 5-30° C. by continuously increasing the operation temperature, to obtain series of phase-change wax products, wherein the pressure for the reduced pressure distillation is 0-1000 pa, the operation temperature at the top of the column is 120-260° C., and the phase -change enthalpy value of the series of phase-change wax products is ≥170 J/g.

2. The method of claim 1, wherein the operation temperature of the hydrogenation reaction is 240-340° C., and the operation pressure is 3-8 MPa.

3. The method of claim 1, wherein the freezing point of the refined Fischer-Tropsch wax is 40-90° C.

4. The method of claim 1, wherein the method further comprises, before the reduced pressure distillation, reducing the content of isomeric-hydrocarbon in the refined Fischer-Tropsch wax to increase the content of normal-alkane in the raw material to 95% or more.

5. The method of claim 4, wherein the method of reducing the content of isomeric-hydrocarbon in the refined Fischer-Tropsch wax is selected from sweating or solvent deoiling.

6. The method of claim 5, wherein the solvent deoiling includes dilution with butanone and crystallization in steps.

7. The method of claim 1, wherein the reduced pressure distillation comprises: under the conditions of a pressure of 1000 Pa and an operation temperature of 140-150° C. at the top of the column, the fraction at the temperature of 280-300° C. is separated, with a melting point of 15±2.5° C. and a phase-change enthalpy value of ≥170 J/g; under the condition of an operation temperature of 150-160° C. at the top of the column, the fraction at the temperature of 300-315° C. was separated, with a melting point of 20±2.5° C. and a phase-change enthalpy value of ≥170 J/g; under the condition of an operation temperature of 160-170° C. Cat the top of the column, the fraction at the temperature of 315-330° C. was separated, with a melting point of 25±2.5° C. and a phase-change enthalpy value of ≥170 J/g; series of phase-change wax products having a melting point of 60° C. can be separated by continuously increasing the operation temperature.

8. The method of claim 1, wherein the reduced pressure distillation comprises: under the conditions of a pressure of 10 Pa and an operation temperature of 115-130° C. at the top of the column, the fraction at the temperature of 350-375° C. was separated, with a melting point of 35±2.5° C. and a phase-change enthalpy value of ≥180 J/g; under the condition of an operation temperature of 130-145° C. at the top of the column, the fraction at the temperature of 375-400° C. was separated, with a melting point of 45±2.5° C. and a phase-change enthalpy value of ≥190 J/g; under the condition of an operation temperature of 145-160° Cat the top of the column, the fraction at the temperature of 400-425° C. was separated, with a melting point of 50±2.5° C. and a phase-change enthalpy value of ≥190 J/g; series of phase-change wax products having a melting point of 60° C. can be separated by continuously increasing the operation temperature.

9. The method of claim 1, wherein the carbon number of each phase-change wax product is 3-5.

10. The method of claim 1, wherein the phase-change temperature of the series of phase-change wax products is 5-80° C.
